(19) United States
(12) Patent Application Publication
(10) Pub. No.: US 2026/0251483 A1
(43) Pub. Date: Aug. 27, 2026

(54) Fiber Sensing by Monitoring Polarization Response Function of Light on Submarine Cables Without Reflectors

(71) Applicant: NEC Laboratories America, Inc., Princeton, NJ (US)

(72) Inventors: Fatih Yaman, Princeton, NJ (US); Andrea D'Amico, Plainsboro, NJ (US); Shaobo Han, Princeton, NJ (US); Eduardo Mateo Rodriguez, Tokyo (JP); Shinsuke Fujisawa, Princeton, NJ (US); Takanori Inoue, Tokyo (JP)

(21) Appl. No.: 19/549,976

(22) Filed: Feb. 25, 2026

Related U.S. Application Data
(60) Provisional application No. 63/762,671, filed on Feb. 25, 2025.
(60) Provisional application No. 63/769,253, filed on Mar. 10, 2025.

(51) Int. Cl. G01D 5/353

(52) U.S. Cl. CPC G01D 5/35358

(57) ABSTRACT

A system and method for distributed polarization sensing on optical communication systems, such as submarine cables, without requiring reflectors. The system leverages existing high-loss-loopback (HLLB) couplers and Rayleigh backscattering to interrogate the fiber link. Interrogation pulses having independent input states-of-polarization (SOPs) are launched, and corresponding output SOPs are measured from the returning partially polarized light. Polarization transfer matrices for different path lengths are estimated using the Kabsch algorithm. To isolate the location of environmental or seismic disturbances while overcoming the non-commutative nature of matrix multiplication, a differential between adjacent transfer matrices is calculated. The disturbances are characterized by computing the eigenvalues of the differential matrices, enabling sub-span resolution over transoceanic distances utilizing standard lasers.

### CROSS REFERENCE TO RELATED APPLICATIONS

This application claims the benefit of U.S. Provisional Patent Application Ser. No. 63/762,671 filed Feb. 25, 2025, and U.S. Provisional Patent Application Ser. No. 63/769,253 filed Mar. 10, 2025, the entire contents of each of which is incorporated by reference as if set forth at length herein.

### FIELD OF THE INVENTION

The present invention relates generally to fiber optical telecommunications systems and technologies. More particularly, the invention relates to sensing seismic and environmental disturbances on optical communication systems having a large number of spans, such as submarine optical transmission systems, without the necessity of wavelength-selective reflectors.

### BACKGROUND OF THE INVENTION

Submarine optical transmission systems are critical infrastructure forming the backbone of global communications. These cables traverse thousands of kilometers across ocean floors and are highly expensive to lay, replace, upgrade, or repair. While modern optical fibers efficiently transmit signals with minimal distortion, they remain highly sensitive to external disturbances. Events such as earthquakes, subsea landslides, tsunamis, ocean swells, and shunt faults alter the phase and polarization of light traveling through the affected fiber.

Current earthquake sensing technologies relying on optical cables generally fall into two categories: forwarding techniques and backscattering techniques. Forwarding techniques transmit a highly stable, low-linewidth laser signal from one end of the fiber and monitor modulation at the distal end. While this provides an extensive sensing range capable of covering transoceanic distances, it measures the accumulated modulation over the entire link, thereby failing to isolate the specific location of the disturbance.

Alternatively, backscattering techniques-often referred to as Distributed Acoustic Sensing (DAS)—rely on Rayleigh backscattering, wherein intrinsic fiber imperfections continuously scatter a small fraction of light back toward the origin. Rayleigh backscattering enables the pinpointing of disturbances down to centimeters. However, this back-reflected light is extremely weak (approximately-40 dB per kilometer at 1550 nm) and is blocked by isolators in repeaters. To bypass these isolators, high-loss-loop-back (HLLB) couplers divert a portion of the scattered light into the returning fiber pair. Due to the weak reflection and high coupling losses, the returning scattered power is typically buried under amplified spontaneous emission (ASE) noise, strictly limiting the effective sensing range of DAS to a single or a few spans.

To improve the signal-to-noise ratio (SNR) over long distances, conventional solutions insert wavelength-selective reflectors at every span to create a designated supervisory channel. Moreover, prior systems frequently monitor the phase of the returning signal. Phase monitoring, however, demands the use of expensive, low-linewidth lasers to prevent laser phase noise from masking the low-frequency signals (milli-Hz to tens of Hz) characteristic of seismic events. Furthermore, existing submarine cables may lack reflectors, and retrofitting deployed cables is cost prohibitive.

Therefore, there is a distinct need in the art for an apparatus and method capable of isolating and characterizing disturbances over transoceanic distances without requiring wavelength-selective reflectors or specialized low-linewidth lasers.

### SUMMARY OF THE INVENTION

An advance in the art is made according to aspects of the present invention which utilizes existing HLLB architectures in submarine cables to achieve distributed polarization sensing without requiring reflectors. The invention measures the complete polarization transfer matrix of the fiber span rather than relying solely on phase or scalar state-of-polarization (SOP) measurements. By monitoring polarization, the system nullifies the adverse effects of laser phase noise, allowing the utilization of less expensive, smaller form-factor lasers.

Because polarization operations inherently involve vector mathematics, accumulated transfer matrices combine via non-commutative matrix multiplication. A naive approach to isolating span-specific data therefore fails. The present invention circumvents this non-commutativity by computing the differential of the transfer matrices from neighboring fiber sections and monitoring the eigenvalues of the resulting matrix. Due to the mathematical principle of matrix similarity, these eigenvalues remain unchanged, permitting the precise isolation of local disturbances even if multiple events occur simultaneously across different spans.

Critically, the present invention successfully utilizes Rayleigh backscattering in the absence of reflectors. While backscattered light in non-polarization-maintaining telecom fibers is not perfectly polarized, the average state-of-polarization (SOP) maintains a degree of polarization (DOP) greater than zero, typically approaching 0.33. Because the reflected light's polarization orientation corresponds to that of the input light, the system measures the average SOP of the back-scattered light to reliably compute the requisite polarization transfer matrices.

As we shall show and describe, our inventive method and systems advantageously i) use existing cable architecture, therefore do not incur additional costs; ii) monitors the full polarization rotation matrix rather than polarization only, or phase only; iii) allows the use of cheaper, more practical lasers that may have large laser phase noise; and circumvents the non-commutativity of the matrix operations by monitoring the eigenvalues which remains unchanged due to matrix similarity condition being satisfied which allows for localizing the disturbances

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative submarine cable system as known in the art.

FIG. 3 is a schematic diagram showing illustrative polarization sensing system schematic according to aspects of the present invention.

FIG. 4 is a schematic diagram illustratively showing what happens if an optical pulse with a width of Tw is launched into a supervisory path in an optical cable. While the returning signals are shown as individual pulses, for easy viewing purposes, they actually look noise-like and continuous-all according to aspects of the present disclosure.

FIG. 5 is a schematic diagram showing illustrative frequency domain implementation of measuring transfer matrix of different paths traveled by sending pulses with known SOPs and measuring corresponding output SOPs. From the known inputs and outputs, corresponding transfer matrix is determined-according to aspects of the present invention.

FIG. 6 is a schematic diagram showing transfer matrix of each span further split into smaller matrices describing smaller sections of the span according to aspects of the present invention.

FIG. 7 is a schematic diagram showing an illustrative setup for validating our inventive technique in which polarization sensor creates a sensing signal, which is combined with ASE based dummy and launched into the down link (forward direction. Returning signal is combined with ASWE loading to adjust its OSNR and delivered back to the polarization sensor. Polarization sensor implements our inventive technique. The link has 4 spans of 50 km in down link and up link. There are loop back couplers at every amplifier between the spans, however, there are no reflectors-according to the present invention.

FIG. 8 is a plot of the spectrum of the sensing signal after it is combined with the ASE dummy and the sensing signal is placed at the edge of the C-band at 1565.5 nm-according to aspects of the present invention.

FIG. 9 is a plot of the spectrum received at the output of the down link before ASE loading is added and after ASE loading. Spectrum is shown in 0.06 nm resolution and the estimated OSNR of the signal at 0.1 nm noise bandwidth is estimated to be −.06 dB-according to aspects of the present invention.

FIG. 10(A) and FIG. 10(B) are plots showing sensing signals generated by the polarization sensor shown schematically in frequency domain and the set of 6 polarizations shown on Poincare sphere-according to aspects of the present invention.

FIG. 11(A) and FIG. 11(B) are plots showing sensing signals generated by the polarization sensor shown schematically in time domain-according to aspects of the present invention.

FIG. 12 are plots showing SOP trace obtained from the signal returning from the beginning of the 4 spans shown in the experimental setup. The SOP traces correspond to the output SOP that corresponds to the input SOP that is launched in the x polarization. The polarization in the link are off—all according to aspects of the present invention.

FIG. 13 are plots showing the traces of the rotation eigenvalues corresponding to the first 3 spans in the link-according to aspects of the present invention.

FIG. 14(A) and FIG. 14(B) are plots showing: FIG. 14(A), observation traced when the polarization scrambler on the first span is turned on at speed level “6”, and the polarization span 2 at speed level “3”, while FIG. 14(B) shows eigen value traces-according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

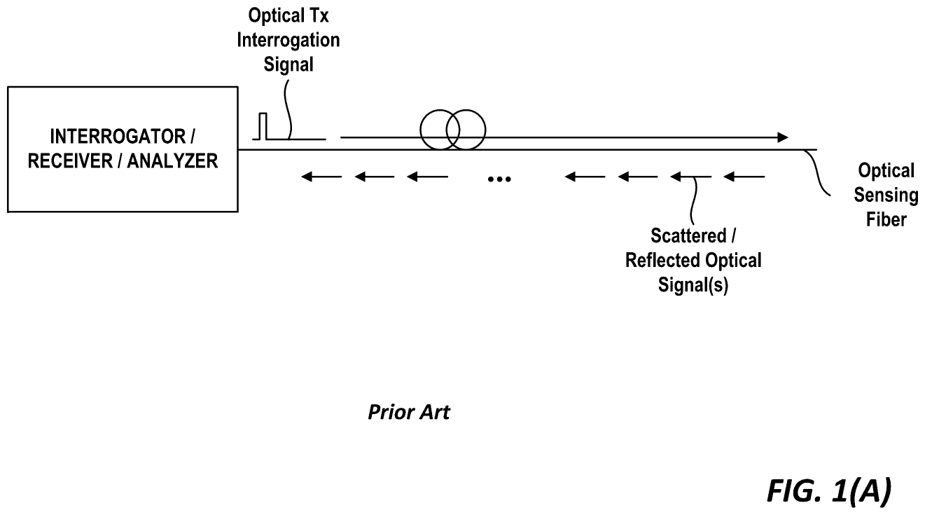

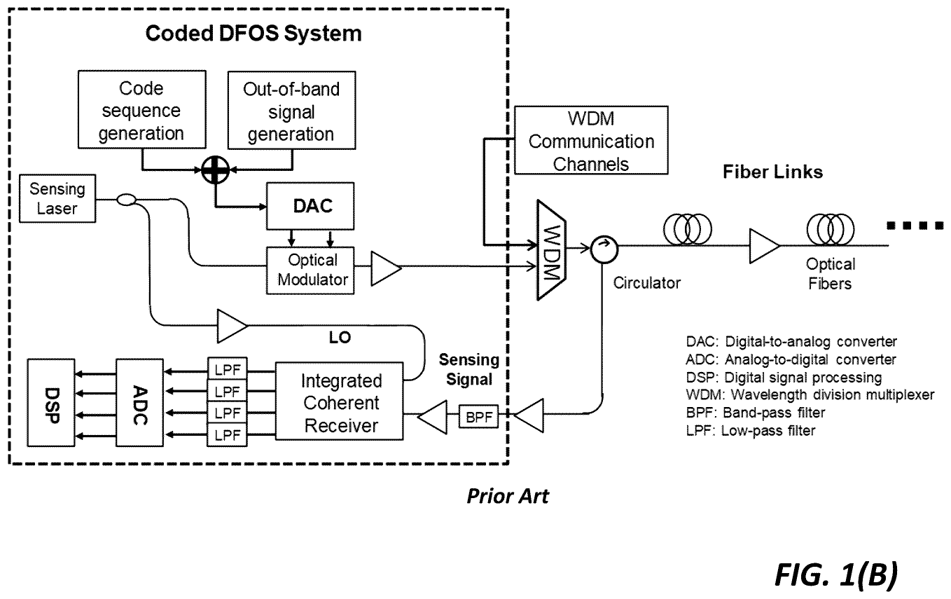

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As we have noted, one problem that our invention solves is how to sense disturbance on the fibers. A particular case that will be the focus in this application is sensing disturbance on fibers that are laid at the ocean bottom, typically for optical telecommunication. A particularly important example is the fibers that are laid in the ocean bottom carrying transoceanic traffic, sometimes referred to as submarine optical communication systems. A particular example of disturbance is caused by earthquakes. Another example is caused by so-called shunt faults that occur on cables. However there may be other sources as well. The particular problems that the innovation solves are improving the signal quality, quantified by the signal-to-noise ratio, and the second one is to improve the resolution, in other words being able to isolate where the disturbance occurred. In addition, we aim to improve characterization of this disturbance, i.e., where it happened, how large was it, its frequency content, etc. Another aim of this innovation is to reduce the cost of the sensing equipment by removing the requirement to use expensive components such as low linewidth lasers. A distinction in this innovation compared to a previous application is that in this proposal a reflector or a similar device designed for returning a selected frequency with high power is not required.

Even though submarine cables are the focus of this this application, our invention is not so limited. Our inventive methods are advantageously applicable to other fiber optic systems. For instance, in terrestrial optical communication systems, or dedicated fiber sensing applications that are not used for optical communication.

In fiber optical telecommunication, optical signals are transmitted over optical fibers. Modern optical fibers are very good at transmitting optical signals without causing large distortions or attenuation to the signal. At the same time fibers are sensitive to disturbances that impact them. A disturbance on the fiber causes a change in the phase and polarization of the light traveling through the fiber.

In submarine systems, optical cables that enclose the optical fibers lay on the ocean bottom and at certain locations they may be buried. When an earthquake occurs, as an example, the phase and polarization of light is modified at the location of the disturbance. By monitoring the phase and polarization of the light information regarding the earthquake can be obtained. Disturbances from other sources such as tsunamis, ocean swells, tides, ocean currents, human activity, cable strumming, etc., can be detected the same way.

Current methods of earthquake sensing on the ocean bottom using optical cables are limited either in their capability to locate where the earthquake happened, or they do not have enough signal-to-noise ratio to be able to sense earthquake over the entire length of the cable which can be thousands of kms long, or they would require the use of expensive and bulky lasers. We describe a solution that senses earthquakes or other disturbances over transoceanic distances, and that can locate the disturbance within a span length (described below) or less. In addition, our inventive methods make use of existing submarine cable designs whether they have wavelength selective reflectors already installed or not, therefore it requires virtually no modification of the cable which can be very costly. Moreover, our inventive method does not require highly specialized, expensive lasers.

Submarine cables are the true backbone of communications in the world. Nearly all the data that travels across continents must be delivered through these cables laid on the seabed. There are several facets of a submarine transmission that sets it apart from other fiber communication systems, i) They are very long, as they typically connect different continents; and ii) It is very expensive to lay cables under water. Once the cable is laid it is extremely expensive to replace, upgrade, or repair the cables. Therefore, even small degradations caused by optical fiber add up and cause reduction of available transmission capacity. Since these systems are very expensive to lay and difficult to upgrade afterwards, it is very important to correctly characterize all the limitations to the capacity accurately and simply.

Another difference that submarine cables exhibit is that most of them have a so called “supervisory system” built into them. Such a supervisory system is usually an optics-based system that is used to monitor the health and operation of the cable. Since the cable becomes nearly inaccessible without damaging it once it is laid on the ocean bottom, it becomes important to monitor its health from the two land-based ends. This is achieved by the supervisory system.

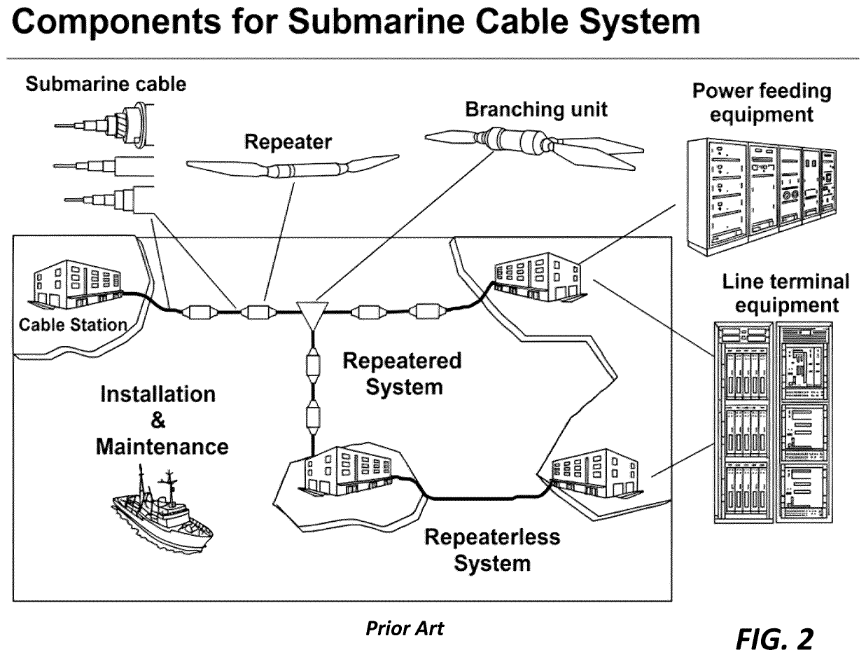

FIG. 2 is a schematic diagram showing an illustrative submarine cable system as known in the art. Referring to FIG. 2, it may be observed that data to be transmitted originates in one of the Cable stations. It is delivered to the other cable stations across the sea through the submarine cable.

Submarine cables have mainly two parts. 1) The cable span, 2) repeaters. The cable span can be 40 km to 150 km or longer, but typically in the 50-80 km range. These are sometimes also referred to as the spans. Cable span includes several elements as shown on the top left of FIG. 1. However, the main part that is our concern regarding the cable span is the optical fibers.

Optical fibers are very thin strands of glass that can guide light in them with low attenuation. Optical fibers are very thin, with about 250 microns diameters typically. Fibers are made of pure silica glass with a cylindrical shape. Light is guided through a doped center called the core surrounded by the rest of the glass called the cladding. Typically, the core diameter is of the order of 5-12 micrometers, and the cladding diameter is about 125 micrometers. The glass section is further coated by polymers to protect it which typically brings the overall diameter to 250 micrometers. In general cables can house a multitude of fibers. Each fiber can carry additional data. The data capacity is therefore proportional to the number of fibers in the cable. Since the fibers are very thin, in principal the capacity of the cable can be increased dramatically by adding more fibers. However, this is not the case because of the power limitation. Fibers have low attenuation, however they still do. With such attenuation, the optical power can drop to 1% after only 1 span. Therefore after one span, light needs to be amplified. Amplification is done by active components called amplifiers. Amplifiers add noise during amplification which is unavoidable. By far the dominant noise added by the amplifiers is the amplifies spontaneous emission (ASE) noise. Amplifiers are housed in the second main part of submarine cable called repeaters. Inside the repeaters there are typically one amplifier dedicated to each fiber. One of the limitations to the number of fibers that can be supported by the cable system is the number of amplifiers that can be fitted into the repeater. The other limitation is the limited electrical power. Each amplifier is electrically powered such that it can amplify the optical power. As mentioned earlier and as will be readily understood by those skilled in the art, this electrical power must be supplied from each ends of the cable system which can be several thousand km long.

To better explain what problems our invention of the instant application solves, we briefly discuss some of the shortcomings of the prior art. As will be understood by those skilled in the art, there are generally two technological approaches for earthquake sensing. One, a forwarding technique, and another, a back scattering technique.

The forwarding technique has the advantage of having a very long range and it can sense over a cable that is several thousands of kms in length. However, it does not provide information about where a disturbance occurs. The scattering-based technique has very good resolution and it can pinpoint a location of a disturbance within a few centimeters however its range is very limited as it can typically operate over a single span.

The forwarding technique can rely on either sensing the phase modulation or polarization modulation induced by the disturbance. Typically, an expensive and highly stable low linewidth laser is sent from one end of the fiber, and the modulation is monitored at the other end. The light is always moving in the forward direction.

In some cases, the light is looped back at the end station to go back to the origin, nevertheless, the light is always moving forward. As a result, at the end of the link the measured modulation is the accumulation of all the modulations induced by all the disturbances along the link. Therefore, the location of the disturbance cannot be retrieved.

The scattering technique relies on a part of an optical signal being continuously scattered back along the fiber to its origin. Fibers, though being quite close to optically perfect, still have imperfections along their length such as fluctuations in glass density. These fluctuations cause a small fraction of light to be scattered in all directions.

As those skilled in the art understand and appreciate, part of this scattering is directed backward by the fiber towards the light's origin. Such backward scatter is generally known as Rayleigh back scatter and though this back scatter is very small, in the range of −40 dB per kilometer of fiber at the typical communication wavelength band around 1550 nm, it has been used to provide a most useful functionality. More particularly, such backscatter is a part of distributed fiber optic sensing systems and are advantageously employed for detecting a location of fiber cuts as well as other environmental factors by monitoring the backscatter power level.

As noted however, the amplifiers have isolators which block this back-reflected (backscatter) light. Fortunately, submarine cables operate as fiber pairs. One fiber takes light from east to west and the other brings it back in the opposite direction. Therefore the solution to bringing back the Rayleigh back scattered light has been diverting a part of the back scattered light into the returning fiber pair before the light is blocked by the amplifiers. However, even though Rayleigh back-scatter is small, it can still interfere with the signal in the returning fiber. Therefore, additional attenuation of this signal is ensured before combining it with the returning traffic. As a result the received Rayleigh scattered power would be extremely small.

As mentioned above, submarine cables use Rayleigh scattering to find locations of cable cuts. In this case, traffic is already cut, so once can use any wavelength to monitor the Rayleigh scattering to find the cable cut location. However, in some cables, it is desired to monitor the health of the cable semi-continuously while communication traffic is flowing without affecting the traffic. Moreover, in such cases a sufficiently high sensitivity is needed, which necessitates boosting the power returning from each span.

One solution that is commonly employed is to insert a reflection point at every span but only in a narrow optical band that is outside of the communication traffic. The actual implementation may not use reflectors, however, as their purpose is to send a part of the light back to the receiver, they will be called reflectors here on. This channel designated for the purpose of monitoring the cable health are sometimes called supervisory channel. To clarify our nomenclature, we will call the couplers used for diverting the Rayleigh scattering back to the receivers as HLLBs, which exist in virtually every submarine cable. On the other hand, some cables have an additional optical supervisory path using some sort of wavelength selective reflectors, which we will call “reflectors”.

The prior art has discussed a solution to this dilemma by using the supervisory path for sensing, but by monitoring the phase of the returning signal. This solution overcame the problem of low power returning because the loop-back path returns a large enough portion of the sensing signal if its wavelength is tuned to the range of the supervisory signal. In this method, a sensing signal with high enough signal—to noise ratio can be achieved over trans-pacific distances and at the same time a resolution of span length can be achieved. However, a downside of this implementation is that it requires very stable lasers with low laser linewidths. This is required to make sure that without the earthquake disturbance the laser phase doesn't change much. This is especially challenging in the low frequency region where the laser phase noise stabilization becomes very difficult, and also that is the region, which is most interesting for many seismic sensing applications, i.e., milli-Hz to tens of Hz band.

A second problem with phase sensing in general is that phase is very sensitive to disturbances. When the disturbances are large, it can overwhelm the sensing equipment.

In another approach we employed, our solution was to monitor polarization instead of phase, while still using the supervisory path. To be more specific, we monitored not the polarization itself only but the full polarization transfer function of the fiber. When polarization is monitored instead of phase, laser phase noise is not an issue. In this case, one can use a cheaper and smaller form factor laser, both of which greatly reduces the cost of the final product.

However, replacement of phase with polarization is not trivial. The main reason is that phase is a scalar quantity, and when phase accumulates from one span to the next, phase from one span to the other is added. Addition of scalar quantities is a commutative operation, which allows for cancellation of accumulated phase up to monitored span, and isolate the disturbances that happened only in that span. Polarization on the other hand is not a scalar, but a vector. The polarization transfer function is a matrix. The polarization transfer matrix accumulates from one span to the other through matrix multiplication which is not a commutative operation. Therefore, a naïve approach to canceling accumulated transfer matrix up to a certain span would fail.

We overcome this problem by monitoring the eigenvalues of the polarization transfer matrix. We show that eigenvalues of the polarization transfer matrix remains unchanged even after multiplication of transfer matrix of multiple spans due to the principle of matrix similarity as we explain further below.

In our current invention, we eliminate such reflectors, or designated supervisory channels while still achieving the same functionality. This is because some of the already installed submarine cables may not have such supervisory channels, and since they are already deployed they cannot be added. Moreover, in the future, more submarine cables may prefer not to have such supervisory channels

A short summary of our invention is as follows. We make use of existing HLLBs built into submarine cables for cable health and environmental sensing purposes, even in the absence of reflectors. A critical aspect of our previous implementations that used reflectors was that the polarization of the reflected light had a very high correlation with the polarization of the incoming light. Basically, when a polarized light is reflected, or diverted, it remains polarized, as long as the signal to noise ratio is high enough.

One important aspect of the present invention is that if reflectors are missing, Rayleigh back-scattering is employed. However, as those skilled in the art will understand and appreciate, one issue is that Rayleigh scattering is distributed, and that fibers are not polarization maintaining. Therefore, the backscatter light that is returning back is a collection of light that has rotated and reflected continuously, therefore, even if the incoming light is perfectly polarized, i.e., degree of polarization takes its maximum value of (DOP)=1, the back scattered light is in general not.

One important aspect of our invention is our observation that-even though back-scattered light is not perfectly polarized—it is not perfectly unpolarized either. A perfectly unpolarized light has a DOP=0, its minimum value. For fibers typically used in for telecom applications, the returning light is partially polarized, meaning DOP>0, and typically on average approaching DOP=0.33. Moreover, the reflected lights orientation of polarization matches that of the input light. As a result, we can use the average state-of-polarization (SOP) of the reflected light as if it was reflected by a “mirror”.

According further to the present invention, we monitor polarization rather than phase, and in particular, we monitor the polarization transfer matrix rather than polarization only. As a result, we can isolate where the disturbance occurred even though matrix operations are not commutative by monitoring the eigenvalues of the polarization transfer matrix.

This is not to say that we cannot monitor both simultaneously, in fact we can both simultaneously

We circumvent the non-commutativity of the matrix operations by monitoring the eigenvalues which remains unchanged due to matrix similarity condition being satisfied. This allows for localizing the disturbances

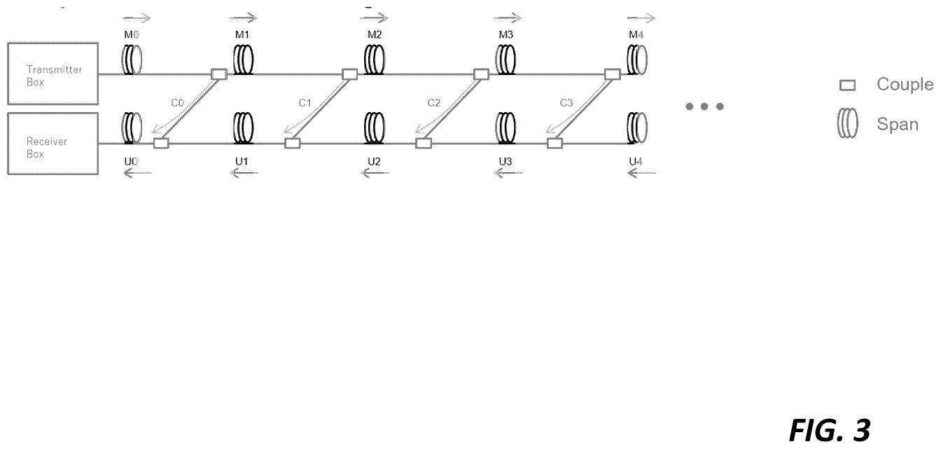

FIG. 3 is a schematic diagram showing illustrative polarization sensing system schematic according to aspects of the present invention. With reference to that figure, it may be observed that i) an interrogation pulse travels down the link. After each span, part of the signal is split, and combined with the return link, while the remainder of the signal continues on; ii) Mₖ(t), Uₖ(t), Cₖ(t) are 3×3 real, unitary matrices, i.e.,

$${M}_{k} ( t ) {M}_{k}^{T} ( t ) = I ,$$

representing the transfer matrix of spans, and spans can. be assumed to be 60~90 km long, while connections Cₖ are very short, oftentimes measured in meters; iii) Mₖ(t), Uₖ(t), can have fast time dependence caused by disturbance; and iv) the total distance may be 10000 km or more and the total number of spans can be more than 100.
Step 1: Measure the Polarization Transfer Matrix from Polarization Measurements

To measure the transfer matrices of the path taken by the light, pulses of width Tw are launched into the cable. As the light travels, part of the light is reflected back into the same fiber in the opposite direction. Just before it reaches the output of the amplifier, a part of this light is coupled back by the HLLB into the returning path at each span.

The pulse width should be shorter or equal to the time of flight for the light to travel one span up and one span down, i.e., T_{W}≤2T_{SP}. Here T_{SP} is the time of flight over a single span. In this fashion, a train of pulses return to the receiver. From their arrival time we can tell which pulse is returning from which location.

When light travels through a fiber span, the span rotates its state of polarization (SOP). SOP of light can be described as a 1×3 real vector, sometimes referred to as the Stokes vector, and for the purposes of this proposal it can be assumed to be a unitary vector. The output SOP depends on the input SOP, and also the state of the fiber span. The state of the fiber span is sensitive to the external disturbances and changes according to the nature of the disturbances. The transfer function of a fiber span can be described as a 3×3 real matrix, in the Stokes space, and for the purposes of this proposal, can be well approximated as a unitary matrix. In such formulation, Stokes vector of the output light can be described as

$$A = M a$$

where A is the output Stokes vector, a is the input Stokes vector, and M is the transfer matrix of the fiber span.

Even if a may be constant, if M is time dependent, due to disturbances, output polarization will be time varying. In some prior art, this was used to detect whether there was earthquake near any part of the cable. From one end of the cable, light with constant SOP is transmitted, on the distal end the SOP is monitored.

Monitoring the changes in the SOP at the distal end, presence of earthquake or other seismic disturbances can be determined. However, in these systems where the earthquake occurred cannot be figured out. In our proposed method, we monitor the output SOP A to estimate the transfer matrix M which contains even more information.

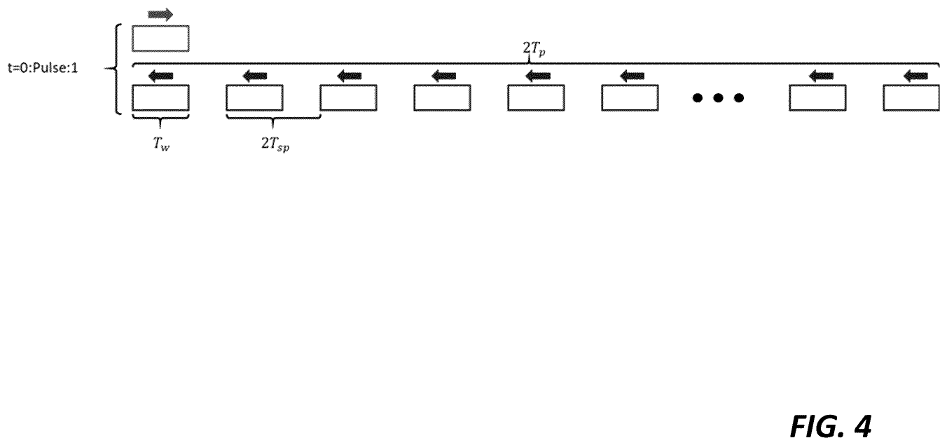

FIG. 4 is a schematic diagram illustratively showing what happens if an optical pulse with a width of T_{W} is launched into a supervisory path in an optical cable. While the returning signals are shown as individual pulses, for easy viewing purposes, they actually look noise-like and continuous-all according to aspects of the present disclosure.

With reference to that figure, one may observe that the SOP of the light returning from each location would be different, as they travel through different lengths. Each one would have information about the state of the transfer matrix of the path they traveled. Each consecutive pulse would have additional information about the extra length they traveled compared to the previous one. However, it is not easy to separate the disturbance added just by the last additional span traveled.

To separate out this information, we monitor the transfer matrix rather than the output SOP. However, the transfer matrix cannot be obtained by only a single measurement of one input SOP and the corresponding output SOP. It is necessary to make multiple measurements each with an SOP independent from the others. The number of SOPs required to measure depends on the implementation constraints, but the more the better but at least two are required. There are different algorithms to achieve this, and Kabsch method is one example.

Therefore, we send two or more pulses each with an independent SOP vector. Based on the input SOPs and the received corresponding output SOPs, we estimate the transfer matrix which can be implemented in the time domain, in the frequency domain, or a combination of them. In the following paragraphs we describe how to estimate the transfer matrix of the path traveled

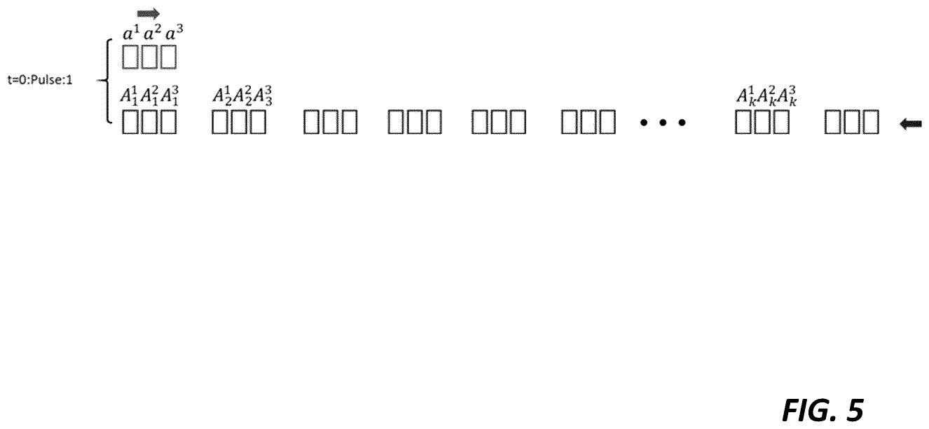

FIG. 5 is a schematic diagram showing illustrative frequency domain implementation of measuring transfer matrix of different paths traveled by sending pulses with known SOPs and measuring corresponding output SOPs. From the known inputs and outputs, corresponding transfer matrix is determined-according to aspects of the present invention.

FIG. 5 schematically shows a frequency domain implementation of how the transfer matrix can be determined. The input pulse is divided into three sections, each with SOP vectors that are mutually independent, and with a different frequency. It is important that the frequencies of the transmitted pulses are close enough that they experience the same transfer matrix up until the longest transmission distance.

In most fibers this is an easy to satisfy condition. In practice the number can be more than 3. In this example, the duration of the three pulses is less than 2T_{SP} as defined above. For the triplet that is sent out, we receive a corresponding triplet from different paths traveled. Like the case in FIG. 4, we can tell the paths traveled by these triplets from their arrival time. From the received signals, by looking at their frequency we can know to which input pulse they correspond to, and thereby what was the input SOP. By using algorithms such as Kabsch algorithm, using the known input SOPs, and corresponding output SOPs we can determine the transfer matrix of each traveled path. In a frequency domain implementation, a¹, a¹, a³ may have mutually exclusive frequency content, they may or may not overlap in time, and their corresponding outputs can be determined based on their frequency.

To expand on the notations, we further split the rotation matrices of the spans into matrices for smaller sections, that are about the same length as the resolution of our measurements. In many systems this corresponds to the pulse width:

$${M}_{k} = {m}_{k 0} {m}_{k 1} … {m}_{k n}$$

Here the lower letter matrices describe the polarization rotation within the short section. For a more complete description we also want to distinguish between the transfer matrix that describes simple propagation over a section and the transfer matrix that describes the reflection that happens in a single section. If the reflection happens in the jth section of the kth span we describe is as \tilde{m}ₖⱼ rather than mₖⱼ to distinguish them from just propagation.

It is also assumed that the input pulses are launched frequently enough that it is faster than the fastest changes that is expected to occur in the cable due to external disturbances. As a result, the triplets in the above examples would be launched in such a quick succession that between them the transfer matrix of the link remains approximately constant. We note the following:
I. Input a′ is 1×3 real vector of unit length. It is fully controllable.
II. The default is that once we send aⁱ, we wait for the last pulse to return before sending the next one. That is our interrogation speed. We also call it sampling speed. For 10000 km, this is roughly 10 Hz. But we have ways to increase it 100 folds or more by employing frequency domain multiplexing. Typical disturbances expected due to seismic activity have vibrations in the 0.2-10 Hz range.
III. Output

$${A}_{k}^{i} ( t )$$

is time dependent due to time dependence of the matrices.
IV. The overall polarization transfer function from transmitter to receiver for a pulse returning from the jth section in kth span is Tₖⱼ.
V. Tₖⱼ can be represented in the form

$${T}_{kj} = {U}_{0} {U}_{1} … {U}_{k - 1} {C}_{k - 1} {m}_{k 0}^{T} {m}_{k 1}^{T} … {m}_{k j - 2}^{T} {m}_{k j - 1}^{T} {{m}^{`}}_{j} {m}_{k j - 1} {m}_{k j - 2} … {m}_{k 0} {M}_{k - 1} … {M}_{0}$$

where Mₖ is the complete rotation matrix, or the polarization transfer matrix corresponding to the kth span in the forward direction, Uₖ is the full rotation matrix corresponding to the kth span in the backward direction, Cₖ is the rotation matrix for the short path that connects the forward path to the backward path at the kth span, mₖⱼ is the transfer matrix for the jth section in the kth span, and \tilde{m}ₖⱼ is the reflection transfer matrix for the location where the light has reflected. Note that after reflection the light travels in the same fiber in the backward direction, and the matrices that describe the propagation in the opposite directions are given by the transpose.
VI. By sending two different S₀ in rapid succession, and comparing the received pulses, we can determine Tₖⱼ·
VII In terms of magnitude, we expect the disturbance rotates the polarization but in the range of a radians or so.
VIII. Given a set of paired input and noisy outputs, the optimal rotation matrix rom Tₖⱼ minimizing the root mean squared deviation can be calculated by using the Kabsch algorithm.

### Step 2: Isolating the Contributions of Different Locations Via Eigenvalue Sensing

Multiple disturbance might be happening simultaneously at different locations. We want to be able to separate signature of these multiple disturbances and where they are happening, at what magnitude, at what frequencies.

In addition, part of the first and last spans of the link are connected to the landing stations while the rest of them are under water. In the absence of disturbances, much of the background vibration noise is expected to originate from the parts that are in the landing stations, because landing stations are very noisy environments. In fact, it is possible that this noise be larger than disturbance signature. Therefore, it is crucial to isolate the mixed contributions of different spans from Tₖⱼ.

To achieve this, we do a “differential” between the transfer matrix of two neighboring sections. Since we operate in terms of the transfer matrices, this “differential” take the form of

$${T}_{k j}^{- 1} {T}_{k j + 1}$$

for the jth section of the kth span. Calculating this differential we obtain

$${T}_{kj}^{- 1} {T}_{kj + 1} = {J}_{kj}^{- 1} {Q}_{kj} {J}_{kj}$$

where we define

$${J}_{kj} = {m}_{kj - 1} … {m}_{k 0} {M}_{k - 1} … {M}_{0}$$

$$and$$

$${Q}_{kj} = {{m}^{`}}_{j}^{T} {m}_{kj}^{T} {{m}^{`}}_{j + 1} {m}_{kj}$$

Although Qₖⱼ is unknown,

$${T}_{kj}^{- 1} {T}_{kj + 1}$$

can be directly computed because both Tₖⱼ and Tₖⱼ₊₁ can be measured as described above. Moreover, Qₖⱼ and

$${T}_{kj}^{- 1} {T}_{kj + 1}$$

are similar matrices sharing the same eigenvalues (as long as Jₖ is invertible, and it is invertible for most systems). Therefore, we can sense the eigenvalue of Qₖⱼ from

$${T}_{kj}^{- 1} {T}_{kj + 1}$$

without the need of Knowing Jₖ!

Note that the contributions of fast time dependence caused by disturbance from previous spans 1 to k has been subsumed into Jₖ. Regardless of earthquake disturbance, since the contributions from different spans are decoupled, even if multiple earthquakes are happening simultaneously at different locations, we can still localize them separately. Meanwhile, noisy landing stations would not cause false alarm at other spans.

Note that

$${T}_{kj}^{- 1} {T}_{kj + 1} ,$$

being unitary in most cases, it would have three eigenvalues, 1, cos (θₖ)+i sin (θₖ), the sum of which equals its trace,

$$( {T}_{kj}^{- 1} {T}_{kj + 1} ) = 2 cos ( {θ}_{k} ) + 1.$$

So the θₖ can be easily computed using inverse trigonometric functions. The computation is fast and can be implemented with low-cost hardware.

The change point detection on multivariate time series has been reduced into multiple univariate time series and allowing applying off-the-shelf methods.

An interesting case occurs in the case where we take a “differential” between the last section of a span, and the first section of the neighboring span. In this case what we sense is the accumulation of all the distortions that happen in the entire span in both directions. To see this, we rewrite the transmission matrix for the light that reflects from the last section (nth) of the kth span

$${T}_{kn} = {U}_{0} {U}_{1} … {U}_{k - 1} {C}_{k - 1} {m}_{k 0}^{T} {m}_{k 1}^{T} … {m}_{k n - 1}^{T} {{m}^{`}}_{n} {m}_{k n - 1} {m}_{k n - 2} … {m}_{k 0} {M}_{k - 1} … {M}_{0}$$

The following section would be the first section (0th) of the (k+1)th span

$${T}_{k + 1 , 0} = {U}_{0} {U}_{1} … {U}_{k - 1} {U}_{k} {C}_{k} {{m}^{`}}_{k + 1 , 0} {M}_{k} {M}_{k - 1} … {M}_{0}$$

Again, we calculate the “differential” between these two sections which in this case becomes

$${T}_{k n}^{- 1} {T}_{k + 1 , 0} = {M}_{0}^{T} {M}_{1}^{T} … {M}_{k - 1}^{T} {m}_{k 0}^{T} {m}_{k 1}^{T} … {m}_{k n - 1}^{T} {{m}^{`}}_{n}^{T} {m}_{k n - 1} {m}_{k n - 2} … {m}_{k 0} {C}_{k - 1}^{T} {U}_{k - 1}^{T} … {U}_{0}^{T} {U}_{0} {U}_{1} … {U}_{k - 1} {U}_{k} {C}_{k} {{m}^{`}}_{k + 1 , 0} {M}_{k} {M}_{k - 1} … {M}_{0}$$

Under the assumption that these matrices are more or less unitary, this expression reduces to

$${T}_{k n}^{- 1} {T}_{k + 1 , 0} = {M}_{0}^{T} {M}_{1}^{T} … {M}_{k - 1}^{T} {M}_{k}^{T} [ {m}_{k n} {{m}^{`}}_{n}^{T} {m}_{k n}^{T} {M}_{k} {C}_{k - 1}^{T} {U}_{k} {C}_{k} {{m}^{`}}_{k + 1 , 0} ] {M}_{k} {M}_{k - 1} … {M}_{0}$$

We also used the definition Mₖ=mₖ₀mₖ₁ . . . mₖₙ in the above expression.

Next we define

$${J}_{k} = {M}_{k - 1} … {M}_{0}$$

$$and$$

$${Q}_{k} = {m}_{k n} {{m}^{`}}_{n}^{T} {m}_{k n}^{T} {M}_{k} {C}_{k - 1}^{T} {U}_{k} {C}_{k} {{m}^{`}}_{k + 1 , 0}$$

which means

$${T}_{k n}^{- 1} {T}_{k + 1 , 0} = {J}_{k}^{- 1} {Q}_{k} {J}_{k}$$

Following the same reasoning as above, the eigen value of the

$${T}_{k n}^{- 1} {T}_{k + 1 , 0}$$

the same as the eigen value of Qₖ because in most systems Jₖ is almost unitary. In this particular case, Qₖ involves not only the first section (j=0) of the span (k+1) where the reflection has occurred but also the entire kth span in both forward and backward directions since it involves both Mₖ and Uₖ in there.

What this means is that, when we take a “differential” between a section in one span, let's say kth span, and a section near the beginning of the subsequent span, i.e. (k+1)th span, we will be able to monitor disturbances that occur anywhere in the kth span. This includes anything that may change the polarization in both fiber pairs in that span. However, we would not be able to pinpoint exactly where it happened in that span, we would be able to know something happened somewhere in the kth span. In some cases, this might be sufficient. In some cases where the ASE noise is high, this might be the only thing we can sense because we can only measure the SOP with sufficiently high SNR only at sections near the beginning of the span.

So far, we have described the spans as consisting of small sections and each section to be roughly the length of the resolution, typically the pulse width, or the effective pulse width, or the effective impulse response of the measuring device, however, in some cases, we may want to combine several of these sections, and use the average of their SOPs for a single unit to improve the SNR, and stability of the SOP

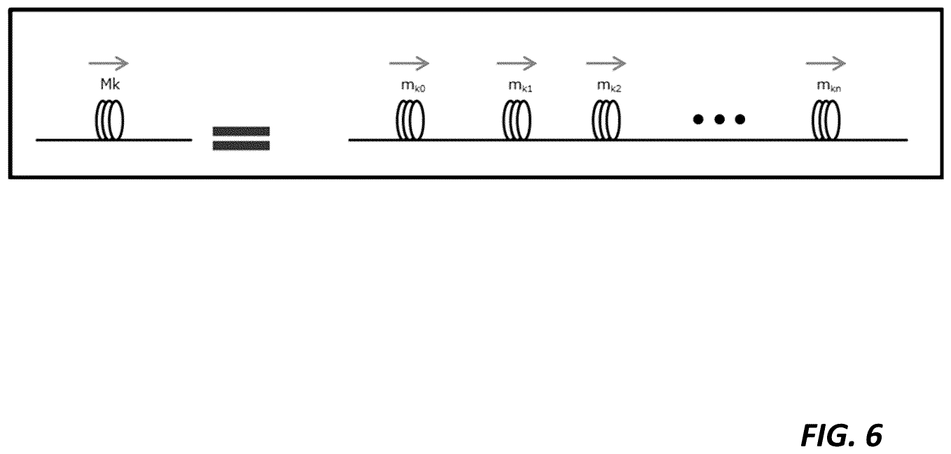

FIG. 6 is a schematic diagram showing transfer matrix of each span further split into smaller matrices describing smaller sections of the span according to aspects of the present invention.

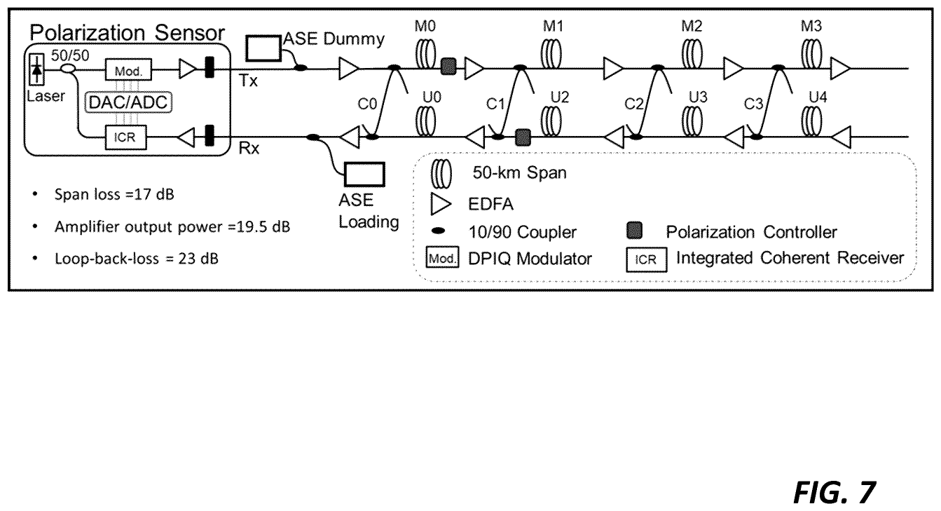

FIG. 7 is a schematic diagram showing an illustrative setup for validating our inventive technique in which polarization sensor creates a sensing signal, which is combined with ASE based dummy and launched into the down link (forward direction. Returning signal is combined with ASWE loading to adjust its OSNR and delivered back to the polarization sensor. Polarization sensor implements our inventive technique. The link has 4 spans of 50 km in down link and up link. There are loop back couplers at every amplifier between the spans, however, there are no reflectors-according to the present invention.

FIG. 7 shows the experimental set up. Polarization sensor implements and generates the sensing signal according to the principles described above. A more detailed description specific to this validation will be given below. The sensing signal is combined with a dummy signal covering the C-band carved out of amplified spontaneous (ASE) noise. The spectrum of the combined signal is shown in FIG. 6. The combined signal is sent down link, i.e., in the forward direction. The down link (forward) and up link (backward) both have 4 spans of 50 km length. After each span, attenuators are added to increase the span loss to 17 dB (not shown). Amplifiers are placed between spans, to compensate for the span loss. Amplifier output power is set to 19.5 dBm. At the amplifier output, the sensing signal average power is −16 dBm. Sensing signal peak-to-average ratio is 5 dB, which corresponds to signal peak power of −11 dBm which is sufficiently low to not cause any impairment on neighboring traffic. The coupling between the uplink and the down link is achieved by using couplers, reflectors, and an optical band-pass filter.

First, the light is coupled out using a 10% coupler. 90% port passes through the link and importantly, there are no reflectors. Light is only back-reflected through Rayleigh scattering continuously throughout the spans. The back reflected light goes through the same coupler again, couples into the down-link amplifier input through the 10% port of a 10/90 coupler. Overall insertion loss of this loop-back path is about 23 dB.

There are two polarization controllers (scramblers) placed in the link-one between the span1 and the amplifier, and the second one between span2 and the amplifier in the returning path as shown by the squares. These polarization scramblers can be turned on and off to emulate polarization rotation caused by external disturbances.

Since this link is much shorter than a typical submarine cable, it does not generate sufficient ASE noise. ASE noise can limit the sensitivity of the sensing method. To test the method with a more realistic noise level, additional ASE is added on the sensing signal

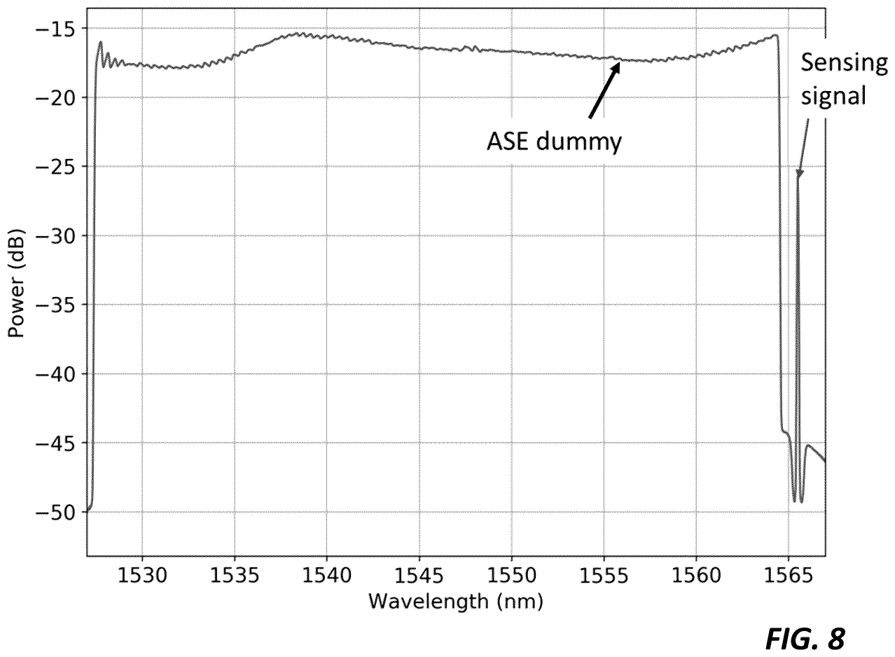

FIG. 8 is a plot of the spectrum of the sensing signal after it is combined with the ASE dummy and the sensing signal is placed at the edge of the C-band at 1565.5 nm-according to aspects of the present invention.

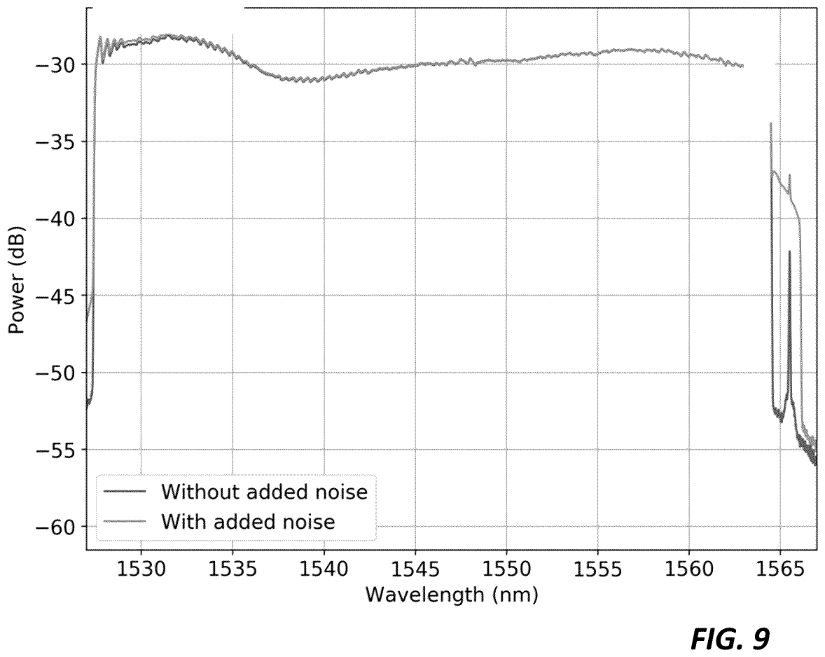

FIG. 9 is a plot of the spectrum received at the output of the down link before ASE loading is added and after ASE loading. Spectrum is shown in 0.06 nm resolution and the estimated OSNR of the signal at 0.1 nm noise bandwidth is estimated to be −.06 dB-according to aspects of the present invention.

After the ASE loading, the OSNR is estimated to be −6 dB at 0.1 nm noise bandwidth. This level of OSNR is equivalent to an ASE noise level that would be produced with a similar link as our experimental set up but with 200 spans. This is long enough for a trans-Pacific link.

FIG. 9 is a plot of the spectrum received at the output of the down link before ASE loading is added and after ASE loading. Spectrum is shown in 0.06 nm resolution and the estimated OSNR of the signal at 0.1 nm noise bandwidth is estimated to be −.06 dB-according to aspects of the present invention.

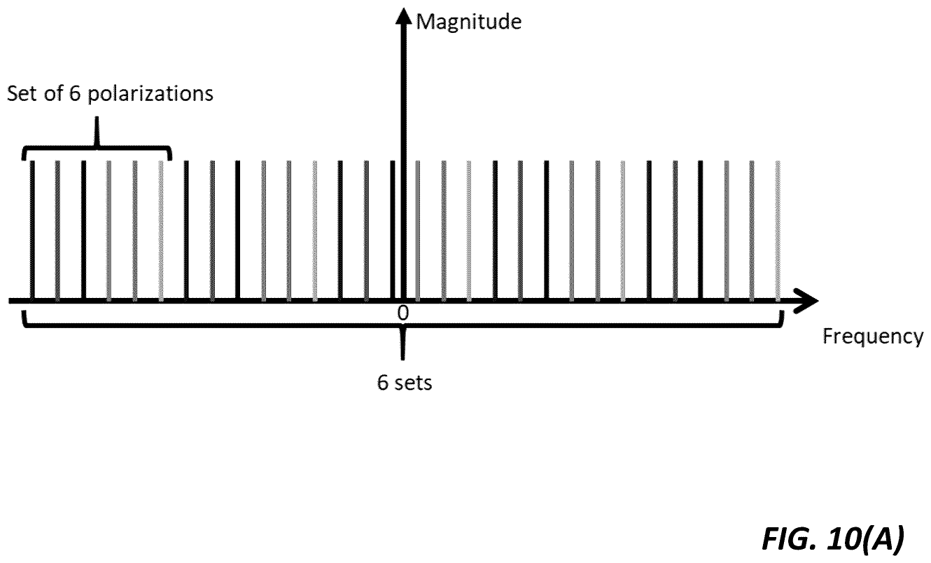

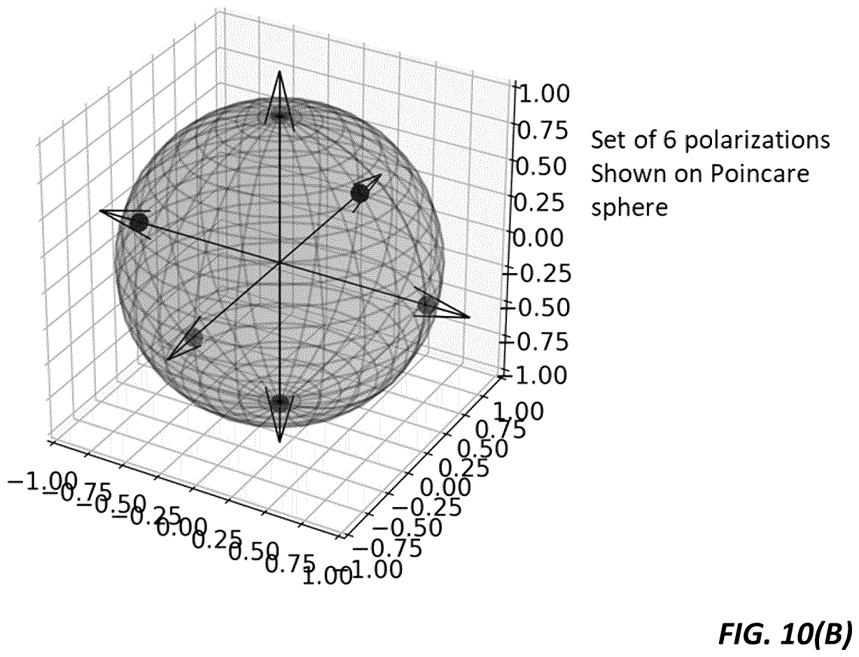

FIG. 10(A) and FIG. 10(B) are plots showing sensing signals generated by the polarization sensor shown schematically in frequency domain and the set of 6 polarizations shown on Poincare sphere-according to aspects of the present invention.

We created 30 carriers, separated by 527 kHz. These 30 carriers are separated into 5 groups with each having 6 carriers. The 6 carriers in each group have 6 different SOPs located on the 6 poles of the Poincare sphere as shown in the figure. The 6 carriers in the same group are modulated to create a pulse, and they are aligned in time. The next group is shifted in time by 0.512 ms. With a total of 5 groups, we have a total frame length of 2.56 ms. As described above, in this experimental validation a frequency domain approach is used. We can tell which output SOP corresponds to which input SOP based on its frequency

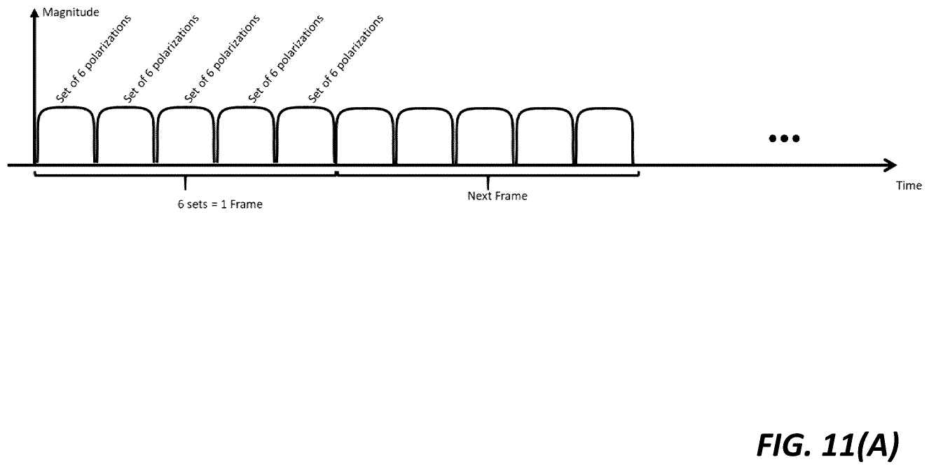

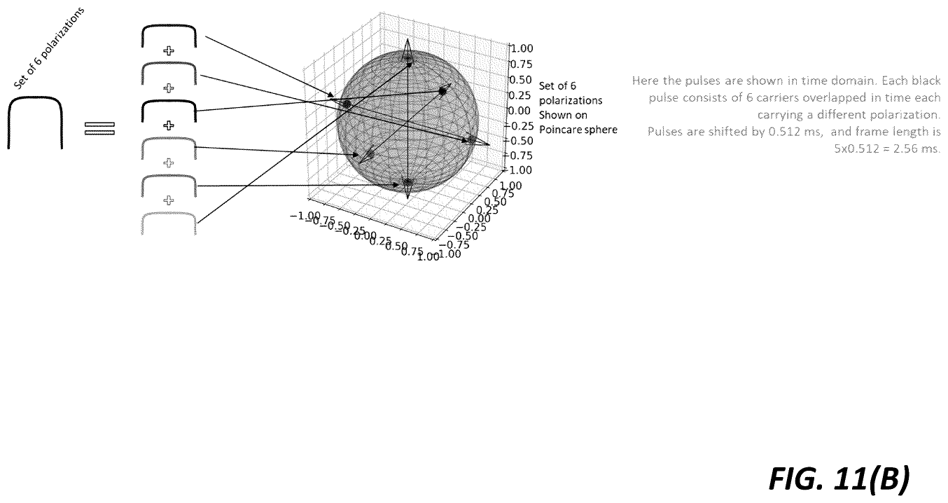

FIG. 11(A) and FIG. 11(B) are plots showing sensing signals generated by the polarization sensor shown schematically in time domain-according to aspects of the present invention.

As shown in the figure, the pulses comprise of the pulses of the 6 carriers which are aligned in time. The next pulse shows the pulses of the next group of 6 carriers which are shifted in time.

Once the sensing signal is received, each carrier is separated based on their frequency. From the frequency and the timing, we map which output SOP corresponds to which input SOP, and also, which path the signal traveled. After that, the eigenvalues are calculated according to the method described above.

In this, we only did “differential” between the initial sections of the subsequent spans, therefore, in this case we are sensing the entire span as a single entity as described above.

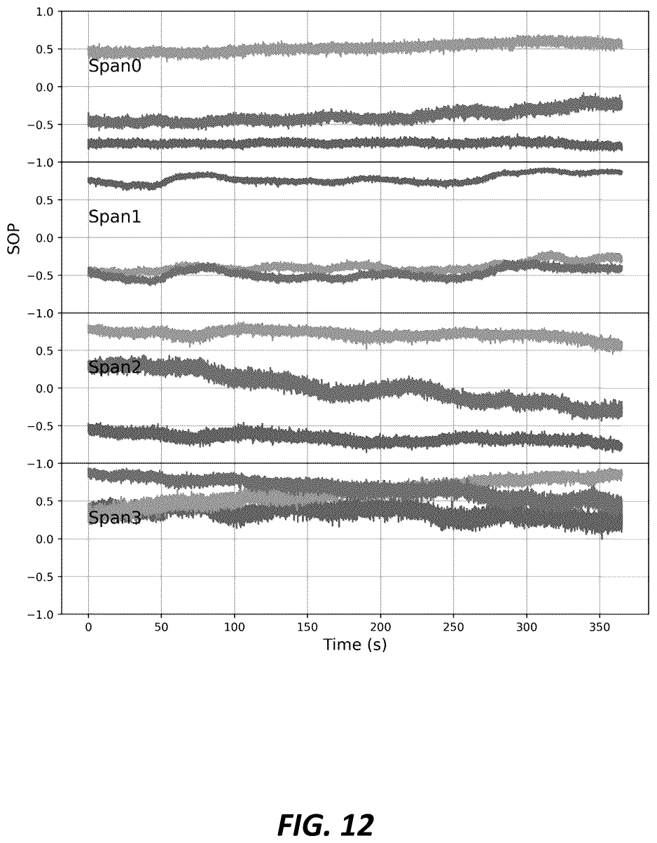

FIG. 12 are plots showing SOP trace obtained from the signal returning from the beginning of the 4 spans shown in the experimental setup. The SOP traces correspond to the output SOP that corresponds to the input SOP that is launched in the x polarization. The polarization in the link are off—all according to aspects of the present invention.

As shown in the figure, the normalized SOP components of the signals returning from the 4 spans in the link are illustrated. In the figure only the output SOPs corresponding to one of the input SOPs is shown. We call this kind of measurement observation traces. Each figure has 3 lines corresponding to the 3 components of the normalized SOP vectors. In this case the polarization controllers are off, therefore the SOPs are very stable other. It can also be seen that, after different paths traveled, the output SOPs are different even though the input SOP is the same. This is because they travel different paths, and the different paths have different polarization transfer matrix.

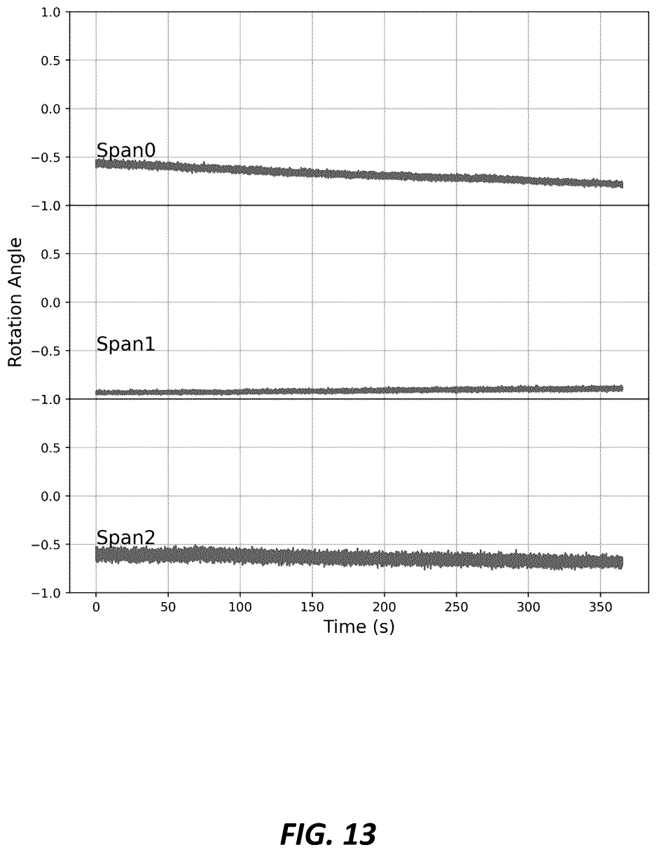

FIG. 13 are plots showing the traces of the rotation eigenvalues corresponding to the first 3 spans in the link-according to aspects of the present invention.

Shown in the figure are the time trace of the eigenvalues calculated for the first 3 spans. As expected they are very stable as there is little disturbance in the link and the polarization controllers are off. Since this is a “differential” measurement that compares the difference between two subsequent spans, we can only monitor what is happening in the first 3 spans. In actual implementation, an additional single reflector or a loop back can be inserted at the end of the link to create one more “differential” with the last span to monitor that one as well.

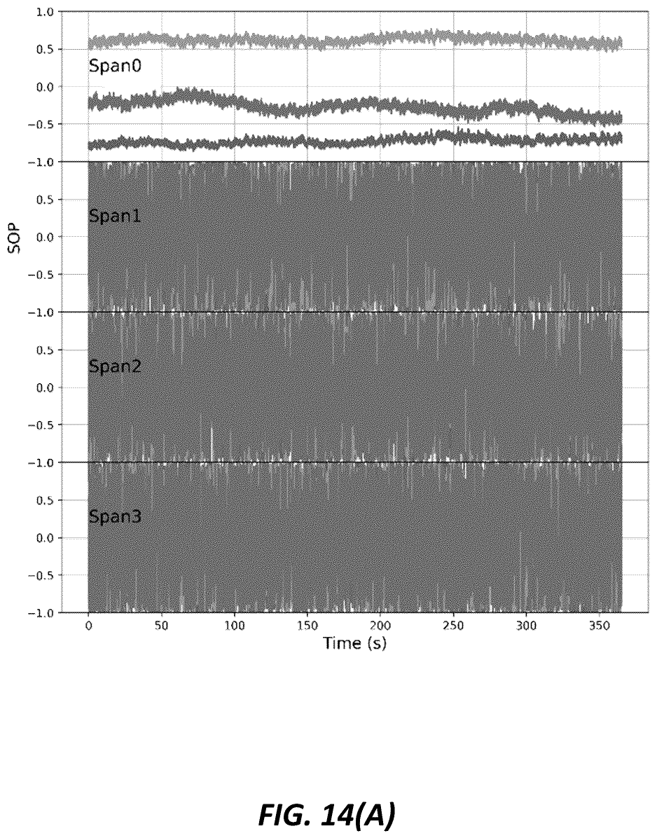

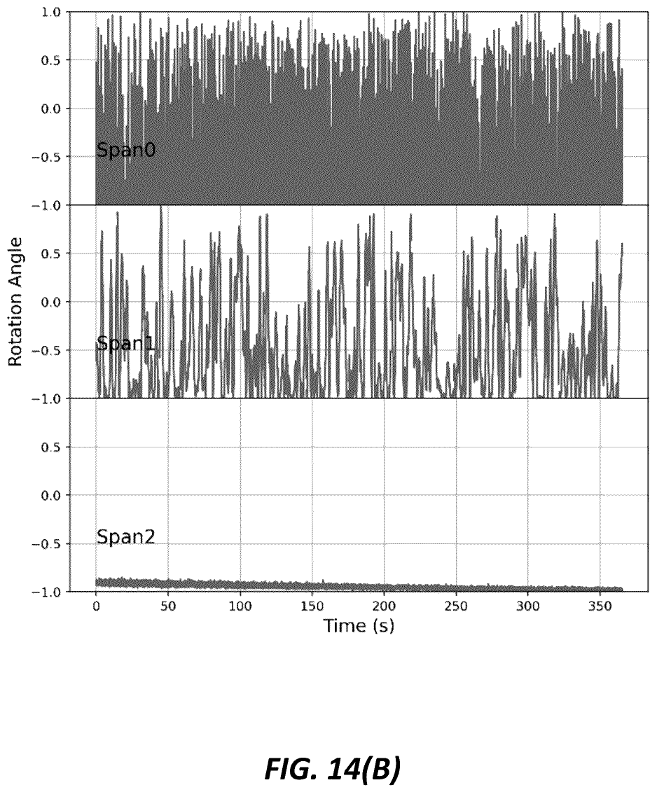

FIG. 14(A) and FIG. 14(B) are plots showing: FIG. 14(A), observation traced when the polarization scrambler on the first span is turned on at speed level “6”, and the polarization span 2 at speed level “3”, while FIG. 14(B) shows eigen value traces-according to aspects of the present invention.

To see whether we can see and also isolate the location of disturbance, turn on both polarization scramblers but at different speeds. The scrambler on the first span is running at a faster speed than the one on the second span. When the polarization scramblers are turned on, they randomly rotate the polarization uniformly over the Poincare sphere. This can be seen from the observation traces in this figure. The signal coming from the first span is still very stable as the light is reflected from the input section of the first span and the polarization scrambler is at the back of the span. Therefore, there is no polarization scrambling in the path of this light. However, the SOPs returning from all the other paths are completely scrambled.

It is not possible to determine which span or spans has disturbance just by looking at the output SOPs from these paths. Even though there is polarization rotation only on the first and second spans, all the signal returning from the subsequent spans are also rotating just as fast. However, when we look at the eigenvalue trace (we also call it rotation angle) on the right, we see that only the trace for span 1 and span2 are rotating where there is polarization scrambler is running but all the third span is stable. This is even though the light returning from the 3^{rd} span does experience rotation from both polarization scramblers. Our method can isolate this rotation to where they occur. In addition, as expected the rotation speed of the first span is faster than the second span. This shows that our method works as intended.

FIG. 14(B) shows the observation trace, the eigen value trace and the corresponding power spectra when both polarization controllers on span 1 and span 2 are turned on. The observed SOP traces from reflector 1 and above are scrambled. Eigenvalues, however, show correctly that there is polarization rotation only on span 1 and span 2.

At this point, those skilled in the art will understand that while we have presented our inventive concepts and description using specific examples, our invention is not so limited. Accordingly, the scope of our invention should be considered in view of the following claims.

1. A method for distributed polarization sensing of disturbances on an optical fiber, comprising:
launching a plurality of interrogation pulses into a forward optical fiber span, wherein each pulse of said plurality comprises a state-of-polarization (SOP) vector that is mutually independent from the others;
receiving a returning optical signal propagating in a backward optical fiber span, wherein said returning optical signal comprises backscattered light coupled from said forward optical fiber span in the absence of wavelength-selective reflectors;
measuring an output SOP corresponding to each respective input SOP from said returning optical signal;
estimating a polarization transfer matrix of a traveled path based on said input SOPs and corresponding measured output SOPs using a Kabsch algorithm;
calculating a differential matrix between a first polarization transfer matrix corresponding to a first fiber section and a second polarization transfer matrix corresponding to an adjacent second fiber section; and
calculating an eigenvalue of said differential matrix to isolate and locate a physical disturbance occurring at said optical fiber.

2. The method of claim 1, wherein said returning optical signal is generated substantially by Rayleigh backscattering and is coupled from said forward optical fiber span to said backward optical fiber span via a high-loss-loopback (HLLB) coupler.

3. The method of claim 1, wherein the step of launching said plurality of interrogation pulses includes emitting pulses having a pulse width, T_{W}≤2T_{SP} where T_{SP} is the time of flight over a single span of the optical fiber.

4. The method of claim 1, wherein said eigenvalue calculation comprises computing a trace of said differential matrix to determine a rotation angle corresponding to the magnitude of the physical disturbance.

5. The method of claim 1, wherein said plurality of interrogation pulses are multiplexed in the frequency domain, and wherein the measured output SOPs are mapped to their corresponding input SOPs based on frequency.
